(19) United States
(12) Patent Application Publication
(10) Pub. No.: US 2002/0171233 A1
(43) Pub. Date: Nov. 21, 2002

(54) System and method for vehicle occupant protection

(76) Inventor: Gregory B. Grace, Mesa, AZ (US)

Correspondence Address: Shaw Pittman LLP, 1650 Tysons Boulevard, McLean, VA, 22102, US

(21) Appl. No.: 10/145,095

(22) Filed: May 15, 2002

Related U.S. Application Data
(60) Provisional application No. 60/291,626, filed on May 18, 2001.

(51) Int. Cl. B60R 21/18

(52) U.S. Cl. 280/733

(57) ABSTRACT

A system and method for protecting a vehicle occupant during a deceleration event, which integrates a dynamically deployed device (“DDD”) with a seat belt restraint system. The invention uses a seat belt to guide the deployment of a DDD (e.g., an air bag). The DDD is anchored to a vehicle. The DDD is slideably attached to a seat belt of the vehicle such that the dynamically deployed device, when deployed, slides along the seat belt and is held in position by the seat belt.

This application claims the benefit of U.S. Provisional Application No. 60/291,626, filed May 18, 2001, which is herein incorporated by reference in its entirety.

### BACKGROUND

1. Field of the Invention

The present invention relates generally to passive vehicle restraint systems and, more particularly, to a system and method for protecting a vehicle occupant during a collision using a dynamically deployed device (“DDD”) integrated with a seat belt restraint system.

2. Background of the Invention

Vehicle manufacturers have long used dynamically deployed devices, such as automobile air bags, to protect vehicle occupants during rapid vehicle deceleration, such as the deceleration encountered in a collision. The manufacturers place these DDDs throughout the vehicle in strategic locations at which occupants can be expected to impact hard components of the vehicle. Early designs focused primarily on DDDs mounted in the steering wheel and dashboard of a vehicle for protection during frontal impacts. More recently, manufacturers have been concentrating efforts on improving occupant protection for vehicle side impacts.

In improving side impact protection, manufacturers have developed numerous side impact passive restraint systems, such as head and torso air bags, inflatable tubular structures (ITSs), air bag curtains, and inflatable seat belt restraint systems. For each of these systems, the general goal is to inflate and position an impact-absorbing structure between an occupant's body and the side of the vehicle. Unfortunately, in pursuing this goal, each of these passive restraint systems bears significant deficiencies.

For head and torso air bags, inflatable tubular structures, and air bag curtains, a fundamental design limitation is the separation between the occupant and the position at which the DDD is fully deployed. Because of variable occupant sizes and positions, the distance of this separation can vary greatly. To maintain comfort, occupants tend to shift body position from side to side. For example, an occupant may lean alternately on a center console and a door armrest. With each position, the occupant places his head and torso at different distances from the side of the car interior. In addition, even assuming a uniform occupant position, the distance of separation still varies with respect to the size of each occupant.

The variable distance can greatly influence the effectiveness of an air bag, ITS, or air bag curtain. Too great of a distance (e.g., leaning on the center console) increases the travel of an occupant's body and increases the impact forces on the air bag. Too small of a distance (e.g., leaning on the door arm rest) places the occupant's body directly in front of the deploying air bag, potentially injuring the occupant with the air bag itself. Thus, there remains a need for a passive restraint system that accommodates the various occupant sizes and positions.

In the prior art, the usual approach in accommodating variable occupant sizes and positions has been to oversize the air bag. Although the larger air bag increases the chance that the air bag will cover all areas at which differently sized and positioned occupants might strike the side of a vehicle, the larger air bag requires more space for storage and more gas for inflation.

The larger air bags also require either additional time to fill the air bags or a more aggressive inflation rate. Allowing more deployment time runs the risk of an occupant's contacting the vehicle structure before an air bag fully deploys. Filling the air bag at an unreasonably rapid, aggressive rate has the potential to injure an occupant due to just the air bag deployment alone.

Another significant drawback of head and torso air bags, ITSs, and air bag curtains is the necessity of a reaction surface. Generally, the ends of these DDDs are attached to vehicle structural members (e.g., door frames) such that they span the width of a window opening when fully deployed. Alternatively, some head and torso air bags are mounted in a seat back or headrest, and deploy in the direction of the side of the vehicle interior. (See, for example, U.S. Pat. No. 5,496,061 to Brown, which discloses a head air bag mounted in a headrest, and U.S. Pat. No. 6,062,593 to Satani et al., which discloses a side air bag mounted in a seat back.) In any of these cases, to provide maximum occupant protection, these DDDs rely on a reaction surface to provide intermediate support along the length of the DDD. Ideally, the reaction surface is a closed side window supported in a window frame. Unfortunately, in vehicle collisions, the side window is often broken or rolled down. Moreover, these devices are inappropriate for convertible vehicles, which lack window frames. In fact, with the top down on a convertible vehicle, the air bag itself could break the unsupported window.

Another significant disadvantage of head and torso air bags, ITSs, and air bag curtains concerns potential interference with the operation of a seat belt restraint system. Conventional three-point seat belts are often mounted to a vehicle structure member in the interior of a car, e.g., a B-pillar between a front side window and a rear side window. The seat belt extends from that structural member across the seat and down to an anchor at the bottom of the seat back. Because the seat belt spans the area in which the head and torso air bag, ITSs, and air bag curtains deploy, during deployment, these DDDs can push the seat belt into an improper position that reduces the effectiveness of the seat belt in restraining an occupant.

U.S. Pat. No. 6,113,135 to Tsutsumi attempts to solve this problem by mounting side air bags within a column that integrally moves with a seat back and by threading the seat belt webbing through a webbing guide at a seat back shoulder portion that is positioned in a vicinity of a vehicle transverse direction inner side portion of the column. The air bag column and the webbing guide on the seat back keep the air bag and seat belt separated. Although this design reduces interference between the seat belt webbing and the side air bags, the design requires multiple, separate components that take up a considerable amount of space at the top of the seat back. Moreover, the design still suffers from the problems discussed above relating to the separation between the occupant and the deployed DDD and the necessity of a reaction surface.

Inflatable seat belt restraint systems overcome some of the deficiencies associated with head and torso air bags, ITSs, and air bag curtains. In inflatable seat belt restraint systems, the seat belt or a portion of the seat belt functions as the DDD by inflating during a collision. Because the seat belt is locked against the occupant during the collision, this approach limits the separation distance between the DDD and the occupant's head, and eliminates the need for a reaction surface. Also, because the seat belt is the DDD, these systems do not require storage space in a vehicle structure. Unfortunately, however, providing an inflatable seat belt presents other substantial drawbacks.

For instance, the inflatable seat belts are subject to daily abuse. With every use of a vehicle, an occupant presumably fastens and unfastens a seat belt. The occupant stretches and twists the seat belt each time. Also, the seat belt can be caught in doors and can be damaged by sharp objects worn by an occupant. The webbing of standard seat belts can withstand most of these abuses. Inflatable seat belts, however, are more susceptible to damage because their DDD portions must be relatively thin and flexible, to allow for rapid inflation.

Inflatable seat belts are also more difficult to retract. The added bulk of the inflatable portions hinders retraction, especially where the inflatable seat belt travels over a D-ring or belt guide. Consequently, the inflatable seat belts do not retract and adjust to the occupant as well as standard seat belts do. Although stronger retraction springs can overcome this bulk and binding, the stronger springs compromise occupant comfort.

In light of the above deficiencies in the prior art, there remains a need for a passive vehicle restraint system that, in providing a vehicle occupant with head protection, reduces separation between a DDD and the occupant's head, eliminates the need for a reaction surface, cooperates with the operation of a seat belt restraint system, protects the DDD from daily abuse, and requires minimal storage space.

### SUMMARY OF THE INVENTION

The present invention is a system and method for protecting a vehicle occupant during a collision. The invention integrates a dynamically deployed device (“DDD”) with a seat belt restraint system to provide the full benefits of an inflatable seat belt restraint system without the drawbacks of inflatable seat belts or head and torso air bags, ITSs, and air bag curtains.

Specifically, the present invention uses a seat belt to guide the deployment of a DDD. The DDD is anchored to a vehicle. The DDD, e.g., an air bag, provides the impact absorption for an occupant. The DDD is slideably attached to a seat belt of the vehicle such that the dynamically deployed device, when deployed, slides along the seat belt and is held in position by the seat belt.

In an embodiment of the present invention, a seat belt restraint guide is attached to the DDD to create a channel. A seat belt is disposed inside the channel, but is not attached to either the seat belt restraint guide or the DDD. In this manner, the seat belt travels freely when the DDD and seat belt restraint guide are stowed and undeployed. When the DDD deploys and expands, the seat belt restraint guide engages the seat belt and guides the deployment of the DDD along the path of the seat belt.

Because the seat belt rests against the body of the occupant (and typically locks during a deceleration event), the DDD deploys proximate to the occupant, thereby reducing the separation distance between the fully deployed DDD and the occupant. The reduced distance decreases travel of the occupant's body and minimizes the potential for injury. For example, when deployed over a shoulder belt from the area of a D-ring, the present invention greatly limits the distance an occupant's head travels during a side impact collision.

Furthermore, the present invention provides for the free travel of the seat belt restraint system when the DDD is in an undeployed state. The undeployed DDD remains stowed and protected, thereby avoiding the daily abuse to which conventional inflatable seat belt restraints are subjected. In addition, because the DDD is not attached to the seat belt and does not interfere with the seat belt during normal use, the present invention avoids the bulkiness and binding associated with conventional inflatable seat belt restraints. Therefore, the occupant enjoys the comfort and unobtrusive appearance of a standard seat belt.

Because the seat belt accurately guides the DDD to deploy proximate to an occupant, the inflatable chamber can be smaller than conventional DDDs, yet still provide the same level of occupant protection. The smaller inflatable chamber requires less inflation gas, a smaller inflator, and less bag material, allowing the DDD to inflate with less energy and to complete inflation within an appropriate time without being dangerously aggressive. The reduced amounts of inflation gas and bag material and the smaller inflators also reduce the cost of the present invention.

The present invention is suitable for any vehicle that uses a seat belt restraint system, and does not require reaction surfaces. Indeed, unlike ITSs and air bag curtains, the invention can be used in convertible vehicles.

### DESCRIPTION OF THE DRAWINGS

FIG. 1 is a schematic diagram of an occupant protection system according to an embodiment of the present invention

FIG. 2 is a schematic diagram showing a front view of a D-ring DDD module, according to an implementation of the occupant protection system of the present invention.

FIG. 3 is a schematic diagram showing a section view of FIG. 2 along section line A-A.

FIG. 4 is a schematic diagram of a D-ring DDD module attached to a seat back, according to an implementation of the occupant protection system of the present invention.

FIG. 5 is a schematic diagram of a D-ring DDD module having a decorative cover, according to an implementation of the occupant protection system of the present invention.

FIGS. 6 and 7 are schematic diagrams illustrating a D-ring DDD module before and after deployment, respectively, according to an implementation of the occupant protection system of the present invention.

FIGS. 8 and 9 are schematic diagrams illustrating a D-ring DDD module mounted to an adjustable headrest in a lowered and raised position, respectively, according to an implementation of the occupant protection system of the present invention.

FIG. 10 is a schematic diagram illustrating a section view of a DDD, a seat belt restraint guide, and a seat belt, according to an embodiment of the present invention in which the DDD and seat belt restraint guide are of a one-piece woven construction.

FIG. 11 is a schematic diagram illustrating a section view of a DDD, a seat belt restraint guide, and a seat belt, according to an embodiment of the present invention in which the DDD and seat belt restraint guide are of a one-piece woven or 2- to 4-panel construction.

FIGS. 12A-12D are schematic diagrams illustrating the deployment of an exemplary DDD that is integrated with the lap belt of a seat belt restraint system and is configured to inflate in the lap of an occupant, according to an embodiment of the present invention.

FIGS. 13A-13D are schematic diagrams illustrating the deployment of an exemplary DDD that is integrated with the lap belt of a seat belt restraint system and is configured to inflate proximate to the torso of an occupant, according to an embodiment of the present invention.

### DETAILED DESCRIPTION OF THE INVENTION

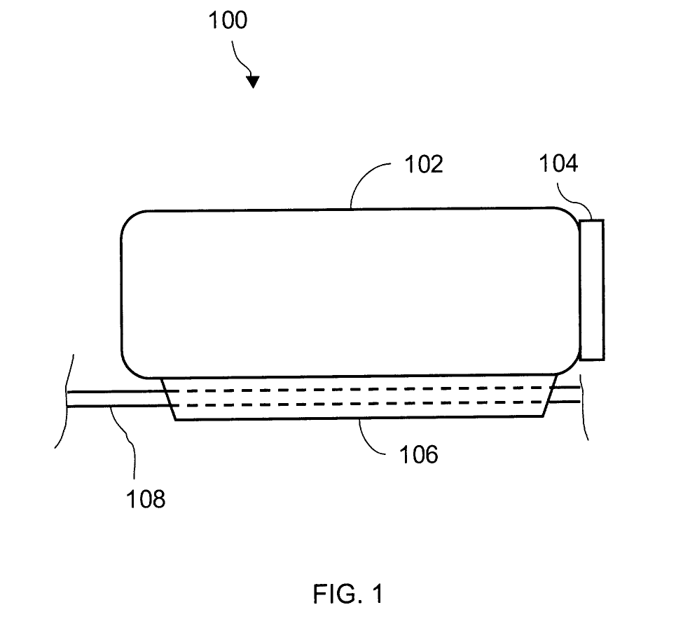

The present invention is a system and method for protecting a vehicle occupant during a collision using a dynamically deployed device (“DDD”) integrated with a seat belt restraint system. FIG. 1 illustrates an occupant protection system 100 in a fully deployed state, according to a representative embodiment of the present invention.

As shown, system 100 includes a DDD 102, an anchor 104, and a seat belt restraint guide 106. Anchor 104 secures DDD 102 to a vehicle structure member, providing a fixed point from which to deploy DDD 102. For example, anchor 104 could be a D-ring module attached to a seat back or to a B-pillar or C-pillar of a vehicle frame. Optionally, anchor 102 can include a housing in which to store DDD 102 in an undeployed condition and to store an inflator that injects gas into DDD 102.

Seat belt restraint guide 106 is attached to DDD 102. The attachment creates a channel through which a seat belt 108 can pass. The channel encloses seat belt 108, but does not restrain the travel of seat belt 108. That is, seat belt 108 is not attached to DDD 102 or seat belt restraint guide 106. Thus, seat belt restraint guide 106 holds DDD 102 proximate to seat belt 108 when DDD 102 is deployed but does not interfere with the operation of seat belt 108 when DDD 102 is stowed. Although not shown in FIG. 1, optionally, seat belt restraint guide 106 can also be attached to anchor 104.

Seat belt 108 is a component of a seat belt restraint system. For example, seat belt 108 could be the shoulder belt or lap belt of a traditional three-point seat belt restraint system. As another example, seat belt 108 could be a shoulder belt of a four-point or five-point seat belt restraint system.

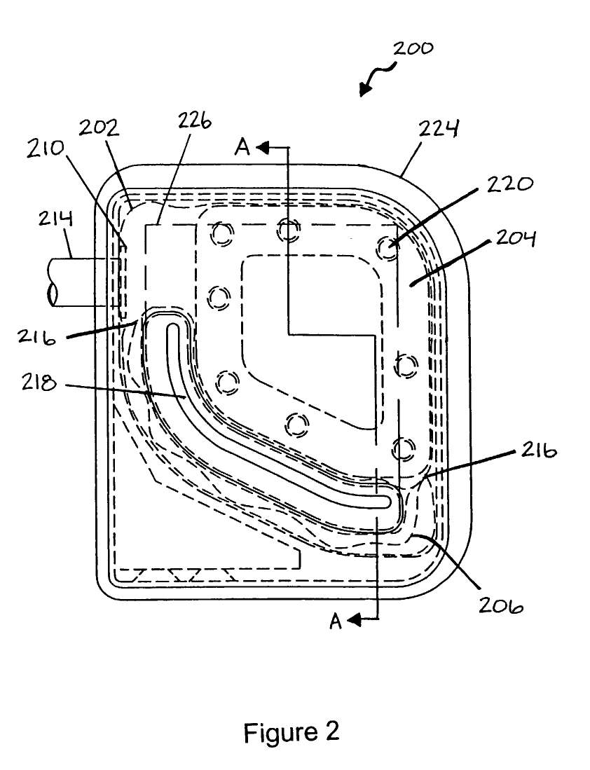

FIGS. 2-11 show an occupant protection system 200 according to an implementation of the present invention. In this implementation, system 200 functions both as the D-ring of a seat belt restraint system and the DDD module of a passive restraint system. Accordingly, in this embodiment, system 200 is referred to as a D-ring DDD module 200.

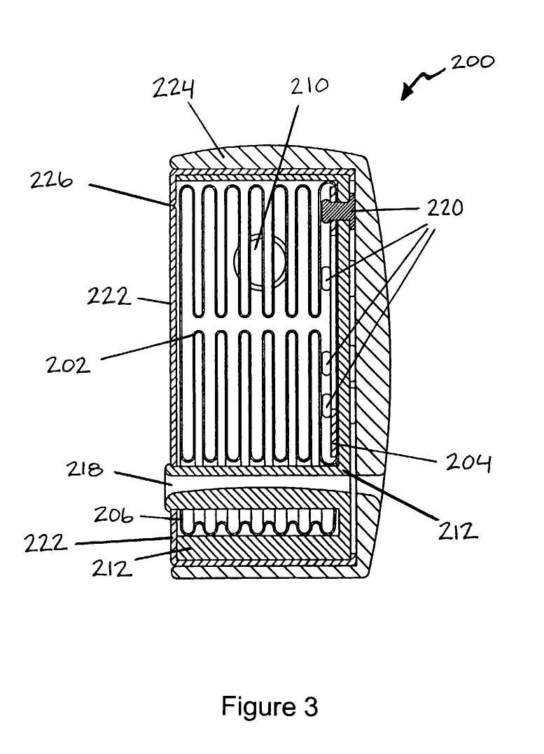

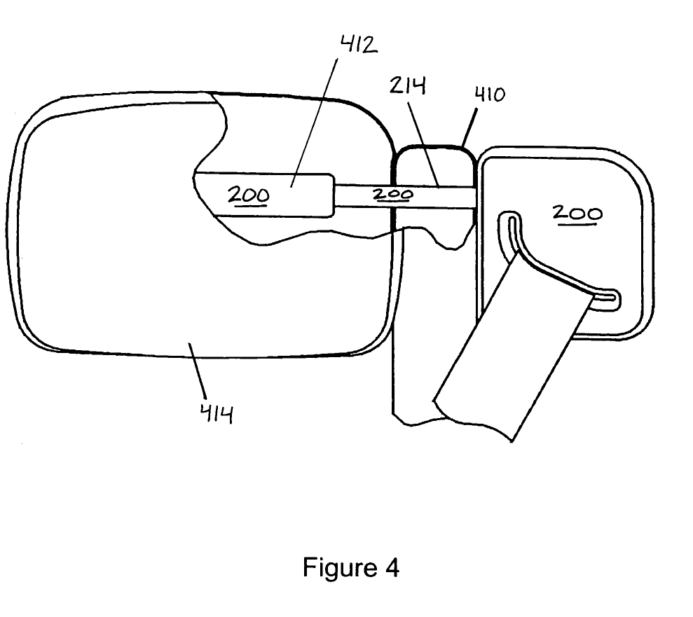

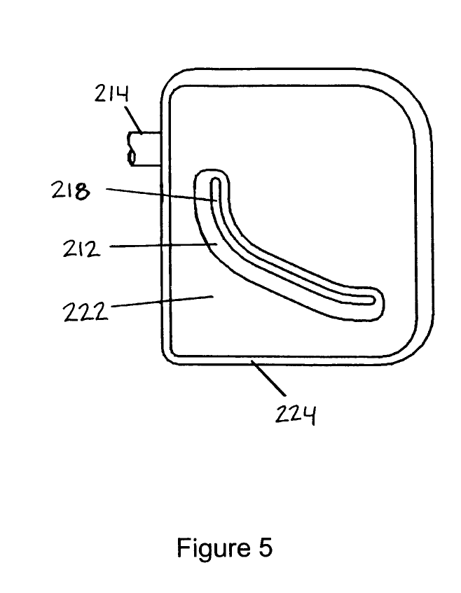

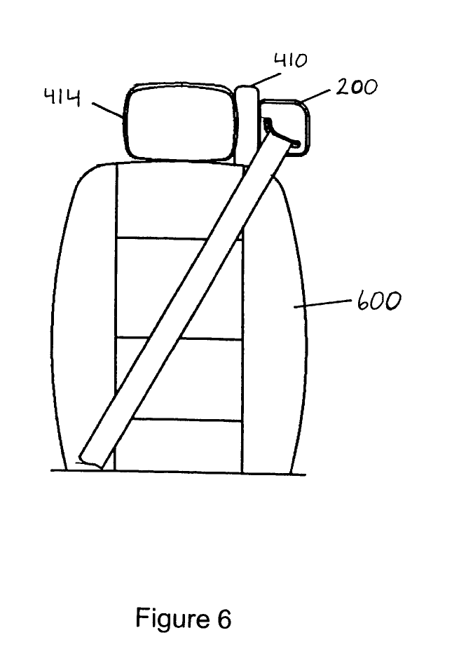

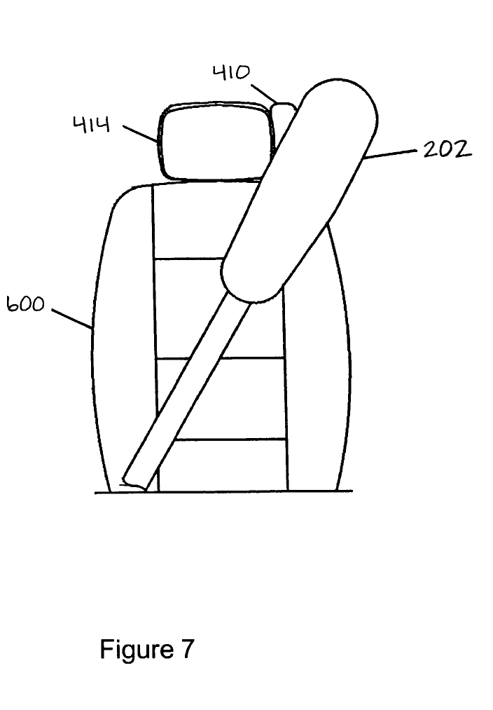

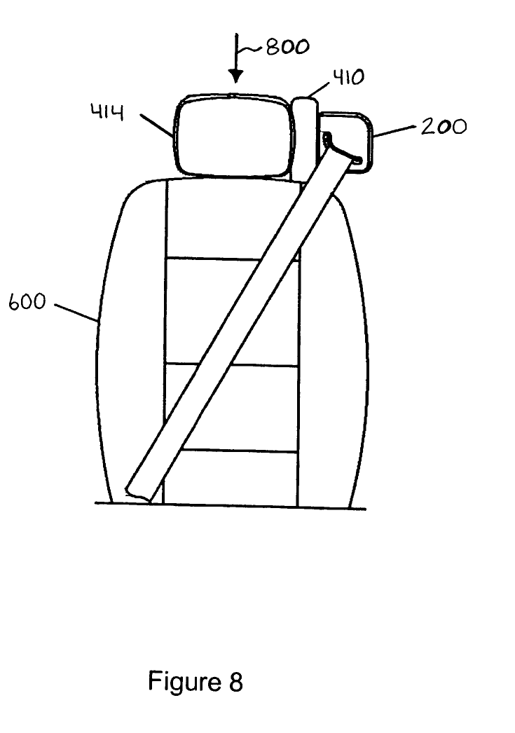

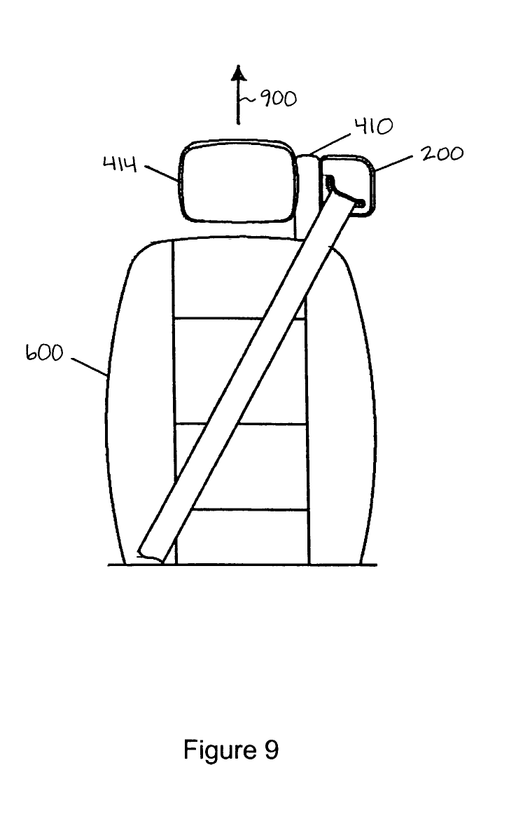

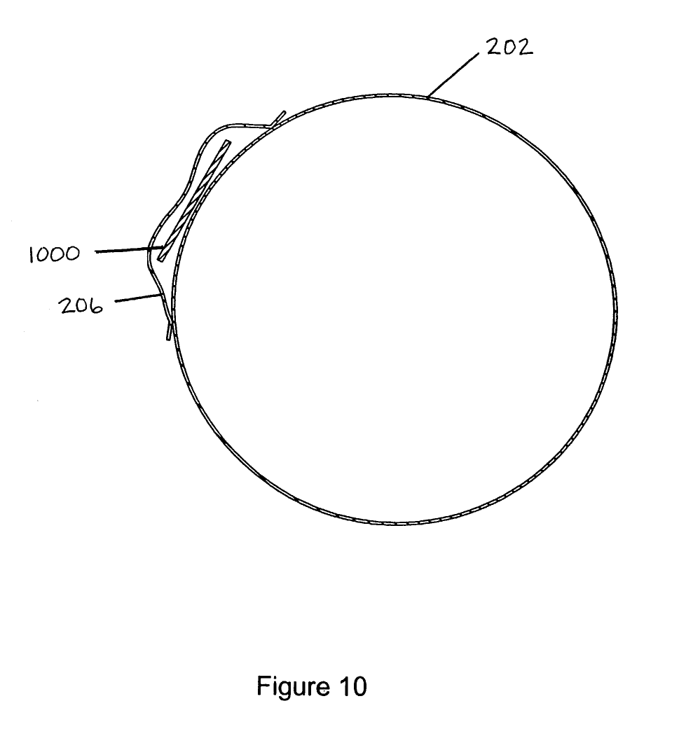

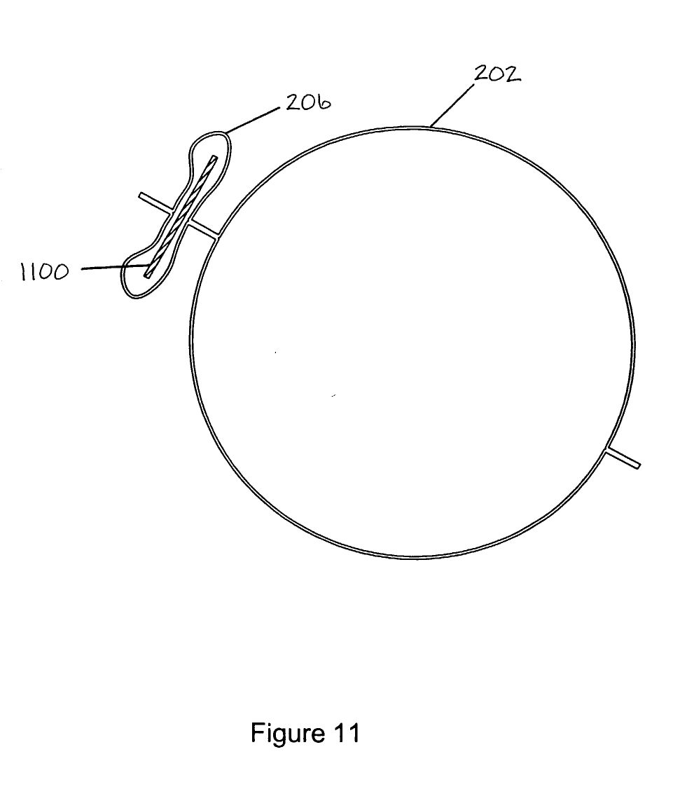

FIG. 2 shows a front view of D-ring DDD module 200. FIG. 3 shows a section view of FIG. 2 along section line A-A. FIG. 4 shows D-ring DDD module 200 attached to a seat back. FIG. 5 shows D-ring DDD module 200 having a decorative cover. FIGS. 6 and 7 illustrate D-ring DDD module 200 before and after deployment, respectively. FIGS. 8 and 9 show D-ring DDD module 200 mounted to an adjustable headrest in a lowered and raised position, respectively. FIGS. 10 and 11 illustrate exemplary methods for constructing DDD 202 and seat belt restraint guide 206.

For illustration purposes, this specification describes embodiments of the present invention in which a DDD deploys over a shoulder seat belt or lap seat belt. However, as one of ordinary skill in the art would appreciate, the present invention is useful for any application that could benefit from the deployment of a DDD along a seat belt restraint system. For example, in addition to a shoulder seat belt or lap seat belt, the present invention could be used to deploy a DDD over any belt of a four- or five-point seat belt restraint system. For this reason, and notwithstanding the particular benefits associated with using the present invention for a shoulder seat belt or lap seat belt, the system and method described herein should be considered broadly useful for any passive restraint system requiring the deployment of a DDD proximate to a vehicle occupant.

As shown in FIG. 2, D-ring DDD module 200 includes a DDD 202, a retaining ring 204, and a seat belt restraint guide 206. DDD 202 is, for example, a head protection air bag of 6 to 11 liters of inflatable volume, and includes an opening 210 through which gas can enter and inflate DDD 202.

The size and shape of DDD 202 depend on desired deployment characteristics and performance, but preferably provide head protection for all possible occupant sizes and seating positions. For example, to minimize bag volume and maximize occupant protection, DDD 202 could be tubular and could taper to a smaller cross-section at its end opposite D-ring DDD module 200. As another example, DDD 202 could be shaped to fit the contour of a vehicle occupant. Optionally, tethers could be used to control the shape and volume of DDD 202.

Retaining ring 204 attaches DDD 202 to a vehicle structure. In this embodiment, as shown in FIG. 3, retaining ring 204 attaches DDD 202 to a housing 212 of D-ring DDD module 200. Fasteners 220 fasten retaining ring 204 to housing 212. Fasteners 220 could be, for example, tamper resistant rivets, tamper resistant torque fasteners, threaded bolts, or other suitable fasteners. To better secure DDD 202 to housing 212, retaining ring 204 is preferably installed inside of DDD 202. Housing 212 of D-ring DDD module 200 mounts to seat back member 410, as shown in FIGS. 4 and 6-9. Thus, retaining ring 204, housing 212, and seat back member 410 effectively function as anchor 104 of FIG. 1.

Seat belt restraint guide 206 is attached to DDD 202 at attachment points 216 to create a channel between guide 206 and DDD 202. A slot 218 of housing 212 is contained within this channel. Attachment points 216 can be single attachments between seat belt restraint guide 206 and DDD 202. For example, a single attachment could be a single area of stitches or adhesive.

Preferably, however, to ensure that seat belt restraint guide 206 smoothly guides DDD 202 during deployment, attachment points are a continuous attachment (e.g., continuous stitches or adhesive) along the length of DDD 202. With a continuous attachment, seat belt restraint guide 206 is one continuous piece of material. For example, guide 206 could be a long rectangle, with each of the two long edges of the rectangle continuously attached to DDD 202.

Optionally, seat belt restraint guide 206 is more than one piece of material attached to DDD 202 to create the channel. For example, guide 206 could be several strips of material fashioned like belt loops.

DDD 202 can be one piece woven, sewn, or bonded together. Seat belt restraint guide 206 can be sewn to panels of a DDD 202, attached to a seam like a separate channel, or woven separately adjacent to a woven DDD 202. FIGS. 10 and 11 show exemplary methods for constructing and attaching seat belt restraint guide 206 to DDD 202. FIG. 10 shows a section view of a one-piece woven construction enclosing a seat belt 1000. FIG. 11 shows a section view of a one-piece woven or 2- to 4-panel construction enclosing a seat belt 1100.

Returning to FIGS. 2 and 3, slot 218, which is inside the channel created by seat belt restraint guide 206, provides a-smooth surface over which a seat belt can slide. In an embodiment of the present invention, slot 218 is coated with a material that has a coefficient of friction lower than that of the material from which housing 212 is made. Preferably, slot 218 is contoured and is coated with a low friction material to minimize seat belt resistance and wear. For example, the low friction material could be TEFLON™, or a powder coating (e.g., a polyvinyl chloride based material), or perhaps an ABS or polypropylene material bonded or snapped over the contoured slot 218 (similar to skid pads on the bottom of a computer mouse). As shown in FIGS. 2 and 3, in an undeployed state, DDD 202 is stowed in a compartment of housing 212 above slot 218, and seat belt restraint guide 206 is stowed in a compartment below slot 218. During daily use, a seat belt passes through slot 218 and does not contact the stowed DDD 202 or seat belt restraint guide 206. Thus, DDD 202 is fully protected from wear and tear.

As shown in FIGS. 2 and 4, D-ring DDD module 200 also includes a duct 214 and inflator 412. Duct 214 provides a conduit through which inflation gas can enter opening 210 and inflate DDD 202. As shown best in FIG. 4, duct 214 is in fluid communication with inflator 412, which produces the inflation gas. In this implementation, inflator 412 is stored in a headrest 414. Optionally, inflator 412 could be stored in seat back member 410 (seat back member 410 is shown in FIGS. 4 and 6-9), in seat back 600 (shown in FIGS. 6-9), or in housing 212 of the D-ring DDD module 200 itself. Of course, in each of these alternative implementations, duct 214 would be located as appropriate, between inflator 412 and opening 210.

To accommodate height-adjustable headrests and D-rings, duct 214 is preferably constructed of flexible or telescoping tubing. In this manner, headrest 414, inflator 412, and D-ring DDD module 200 can vertically adjust together or independently. Optionally, duct 214 could be constructed of rigid tubing, thus requiring headrest 414 and D-ring DDD module 200 to maintain the same relative vertical position. This coordinated adjustment ensures that D-ring DDD module 200 is positioned at a height appropriate for the size of the vehicle occupant. That is, when an occupant adjusts headrest 414 to match the position of the occupant's head, D-ring DDD module 200 adjusts along with headrest 414 to a position appropriate for that occupant. FIGS. 8 and 9 illustrate the coordinated movement of headrest 414 and D-ring DDD module 200, with FIG. 8 showing a lowered position 800 and FIG. 9 showing a raised position 900.

To protect DDD 202 and seat belt restraint guide 206, D-ring DDD module 200 also includes a cover 222, as shown in FIGS. 3 and 5. Cover 222 attaches to housing 212 with rivets, snaps, bolts, or other suitable fasteners, and contains an opening that fits around slot 218. Cover 222 also contains a tear seam 226 along which cover 222 opens during deployment. Tear seam 226 controls the direction in which DDD 202 and seat belt restraint guide 206 deploy as they emerge from housing 212.

As shown in FIGS. 2, 3, and 5, to provide a complete and aesthetically pleasing assembly, D-ring DDD module 200 further includes a decorative cover 224 over cover 222. Decorative cover 224 hides the fasteners of cover 222 and provides a neater appearance.

In view of the above structure, the present invention operates in the following manner. In response to an impact on the vehicle, inflator 412 receives a signal to discharge its inflation gas. Inflator 412 discharges the inflation gas through duct 214 and opening 210, and into D-ring DDD module 200. As the inflation gas begins to inflate DDD 202 and the pressure on cover 222 increases, tear seam 226 separates, opening cover 222 and allowing DDD 202 to further expand.

As DDD 202 inflates, it pulls seat belt restraint guide 206 out of housing 212. Because a seat belt is enclosed in the channel created by seat belt restraint guide 206, DDD 202 and guide 206 slide along the seat belt, following the path of the seat belt. As DDD 202 reaches full inflation, the seat belt, seat belt restraint guide 206, and retaining ring 204 control the positioning of DDD 202. Thus, in a fully deployed condition, DDD 202 is firmly positioned against the seat belt and the occupant to provide superior side impact head protection. As a significant benefit, with the seat belt and D-ring DDD module 200 holding DDD 202 in place, the present invention does not require a reaction surface such as a pillar, roof rail, or side window.

Even if an occupant is not wearing a shoulder belt restraint during a side impact collision, the present invention can still provide some degree of head protection. In such a situation, the present invention would operate as described above. DDD 202 would still be anchored by D-ring DDD module 200 and would be guided by the seat belt restraint. However, because the three-point seat belt restraint is not fastened, DDD 202 would deploy along the side of the occupant's head and upper torso, instead of across the occupant's chest. Even in this position, DDD 202 would provide some head protection because of the proximity of D-ring DDD module 200 to the occupant's head.

In an alternative embodiment of the present invention, D-ring DDD module 200 mounts to a vehicle structure member, rather than to the seat as described above.

For example, D-ring DDD module 200 could be mounted on a pillar or roof rail. In such a case, inflator 412 could be also be mounted in a pillar or roof rail, or could be mounted inside housing 212 of D-ring DDD module 200.

The components of the present invention can be constructed of any of the known materials used in vehicle passive restraint systems and vehicle seat belt restraint systems. For example, a suitable material for DDD 202 and seat belt restraint guide 206 is 210-denier silicone coated nylon fabric. A suitable material for retaining ring 204 is, for example, plated or painted cold rolled steel. Suitable materials for housing 212 include, for example, cast aluminum and fiber reinforced plastic (injection molded). Suitable materials for cover 222 and decorative cover 224 include, for example, TPE, TPO, or ABS plastic.

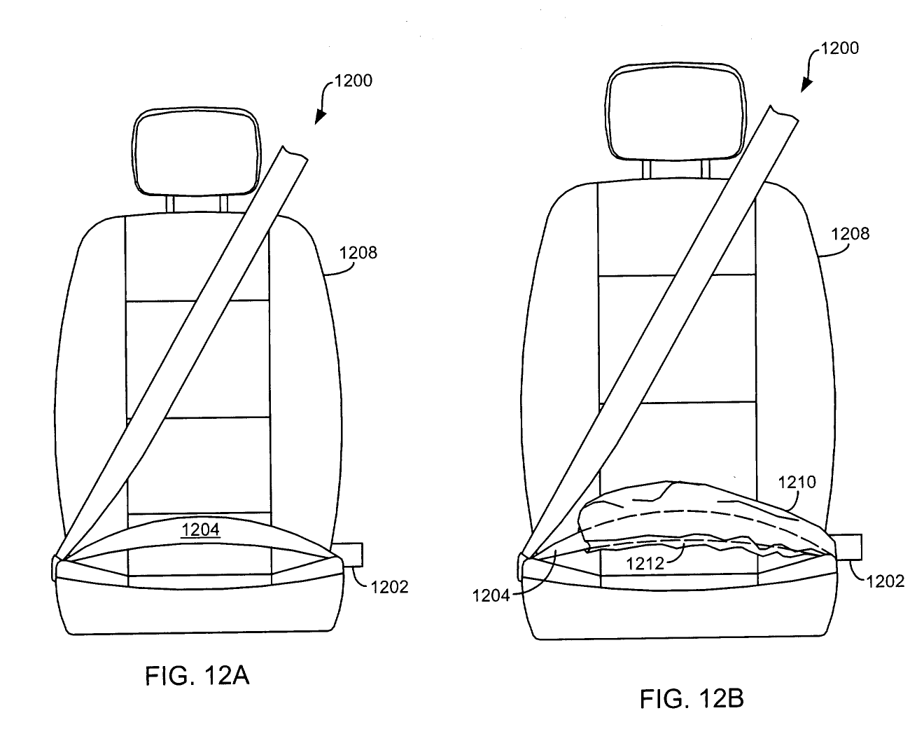

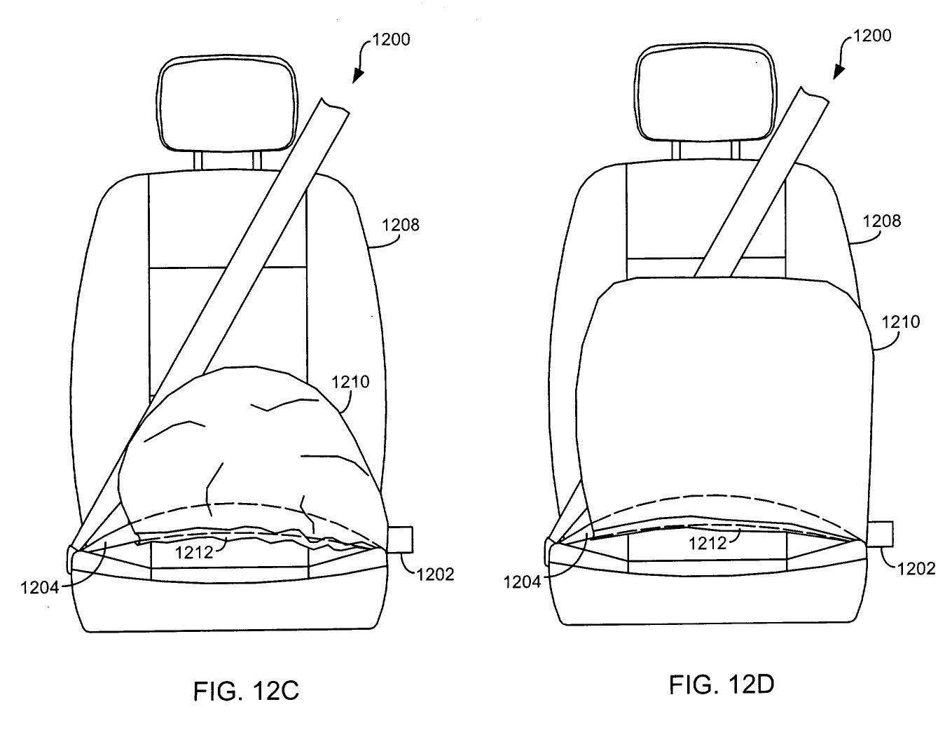

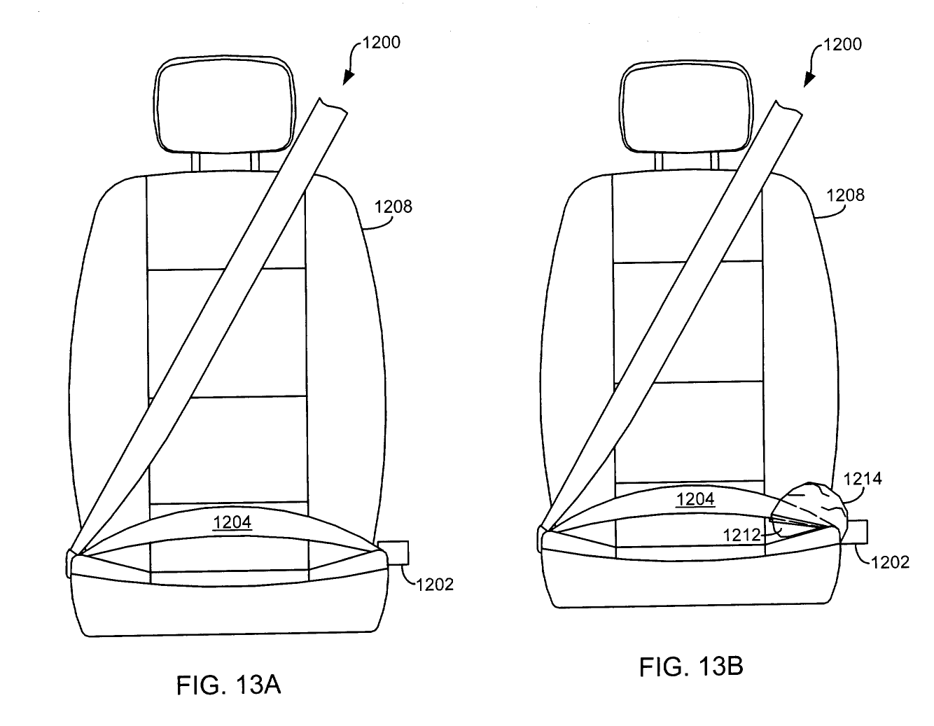

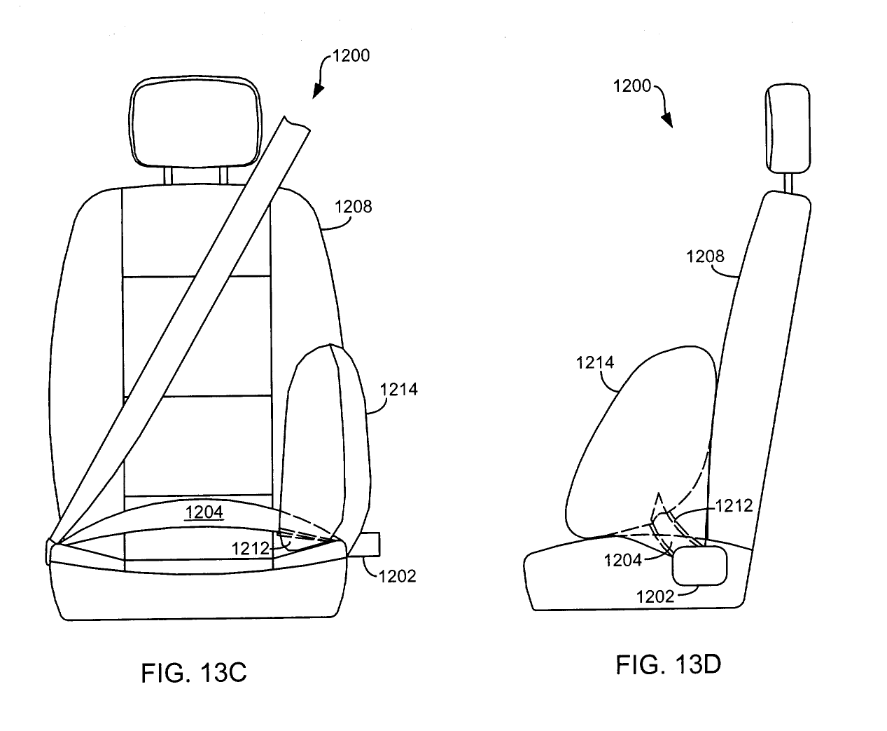

FIGS. 12A-13D show an occupant protection system 1200 according to another implementation of the present invention, in which a DDD module 1202 is integrated with the lap seat belt 1204 of a seat belt restraint system. In this implementation, lap belt 1204 guides deployment of the DDD. DDD module 1202 is preferably positioned proximate to the anchor that secures lap belt 1204 to the vehicle structure. In this manner, DDD module 1202 does not obstruct the occupant and can deploy the DDD in a direction toward the lap of the occupant.

DDD module 1202 can be integrated with the anchor of the lap belt into a single component or can be a separate component through which the lap belt travels.

DDD module 1202 can also be integrated as part of the seat 1208. In any case, DDD module 1202 includes an anchor 104 as described above in reference to FIG. 1. To provide this anchor, DDD module 1202 can be, for example, mounted to the seat, mounted to the lap belt anchor, or mounted directly to the vehicle structure.

FIGS. 12A-13D illustrate two examples of DDDs that can be deployed along lap belt 1204 from DDD module 1202. FIGS. 12A-12D illustrate the deployment of a lap air bag. FIGS. 13A-13D illustrate the deployment of a torso air bag. These particular types of DDDs are exemplary only. As one of ordinary skill in the art would appreciate, other types of DDDs could be deployed from this configuration.

FIGS. 12A-12D illustrate the deployment of a lap air bag 1210 at incremental stages of inflation. FIG. 12A shows DDD module 1202 in an undeployed state with lap belt 1204 in its normal operational position. In this undeployed condition, lap belt 1204 can move freely through DDD module 1202.

FIG. 12B shows system 1200 shortly after deployment, with the lap air bag 1210 partially inflated across lap belt 1204. As shown, lap belt 1204 is disposed between lap air bag 1210 and the seat belt restraint guide 1212 that is attached to lap air bag 1210. As with the D-ring DDD module 200 described above, lap belt 1204 and seat belt restraint guide 1212 control the positioning of the inflating lap air bag 1210.

At a subsequent stage of deployment, FIG. 12C shows lap air bag 1210 nearing full inflation as it rises into position to occupy the lap of an occupant (not shown). Finally, FIG. 12D shows lap air bag 1210 fully inflated and held in place by lap belt 1204. In this position, lap air bag 1210 provides an occupant with frontal impact protection.

FIGS. 13A-13D illustrate the deployment of a torso air bag 1214 at incremental stages of inflation. FIG. 13A shows DDD module 1202 in an undeployed state with lap belt 1204 in its normal operational position. In this undeployed condition, lap belt 1204 can move freely through DDD module 1202.

FIG. 13B shows system 1200 shortly after deployment, with the torso air bag 1214 partially inflated across lap belt 1204. As shown, lap belt 1204 is disposed between torso air bag 1214 and the seat belt restraint guide 1212 that is attached to torso air bag 1214. Lap belt 1204 and seat belt restraint guide 1212 control the positioning of the inflating torso air bag 1214.

At a subsequent stage of deployment, FIG. 13C shows torso air bag 1214 fully inflated into position, held in place by lap belt 1204 between the torso of an occupant (not shown) and the interior side of the vehicle (also not shown). FIG. 13D shows the fully inflated torso air bag 1214 from a side view. In this position, torso air bag 1214 provides an occupant with side impact torso protection.

Although this specification describes the present invention in the context of air bags, one of ordinary skill in the art would appreciate that other dynamically deployed devices could operate equally effectively in deploying along the length of a seat belt. For instance, an inflatable tubular structure (ITS) could deploy along the seat belt instead of the above-described air bag. In such a case, the ITS would remain inflated after deployment (whereas an air bag would not).

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible.

Therefore, the particular order of the steps set forth in the specification should not be construed as limitations on the claims. In addition, the claims directed to the method and/or process of the present invention should not be limited to the performance of their steps in the order written, unless that order is explicitly described as required by the description of the process in the specification. Otherwise, one skilled in the art can readily appreciate that the sequences may be varied and still remain within the spirit and scope of the present invention.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What is claimed is:

1. A system for protecting an occupant of a vehicle comprising:
(a) a dynamically deployed device;
(b) an anchor adapted to attach the dynamically deployed device to the vehicle;
(c) a guide attached to the dynamically deployed device such that a channel is created between the dynamically deployed device and the guide; and
(d) a seat belt disposed in the channel,
wherein, upon deployment of the dynamically deployed device, the guide engages the seat belt to guide the dynamically deployed device to an inflated position.

2. The system of claim 1, wherein the guide is attached to at least one of the anchor and the vehicle.

3. The system of claim 1, wherein the dynamically deployed device is one of a head air bag, a torso air bag, a lap air bag, and an inflatable tubular structure.

4. The system of claim 1, wherein the anchor comprises a D-ring, and wherein the seat belt comprises a shoulder seat belt.

5. The system of claim 4, wherein the D-ring is attached to a seat of the vehicle.

6. The system of claim 4, wherein the D-ring is attached to a structural member of the vehicle.

7. The system of claim 6, wherein the structural member is one of a roof rail and a pillar.

8. The system of claim 1, wherein the seat belt comprises a lap belt, and wherein the anchor comprises a lap belt anchor that anchors the lap belt to the vehicle.

9. The system of claim 1, wherein the seat belt comprises a lap belt, wherein the lap belt is attached to the vehicle by a lap belt anchor, and wherein the anchor is attached to the vehicle proximate the lap belt anchor.

10. The system of claim 1, wherein the anchor is attached to a seat of the vehicle.

11. The system of claim 1, wherein the anchor comprises a housing, the housing having:
(i) a first compartment adapted to stow the dynamically deployed device;
(ii) a second compartment adapted to stow the guide; and
(iii) a slot between the first compartment and the second compartment, wherein the slot is adapted to receive the seat belt such that the dynamically deployed device and the guide, when stowed, do not contact the seat belt.

12. The system of claim 11, further comprising a retaining ring that attaches the dynamically deployed device to the housing.

13. The system of claim 11, wherein the housing is made of a first material and the slot is coated with a second material having a coefficient of friction less than the first material.

14. The system of claim 11, further comprising a cover mounted over the first compartment and the second compartment of the housing.

15. The system of claim 14, further comprising a decorative cover mounted over the cover and the housing.

16. The system of claim 1, wherein the anchor contains an inflator for injecting inflation gas into the dynamically deployed device.

17. The system of claim 1, wherein the dynamically deployed device contains a port, and wherein the system further comprises:
(a) a duct in fluid communication with the port; and
(b) an inflator in communication with the duct.

18. The system of claim 17, wherein the inflator is stored in a seat headrest of the vehicle.

19. The system of claim 1, wherein the dynamically deployed device contains a port, and wherein the anchor contains an inflator in communication with the port.

20. The system of claim 1, wherein the guide is continuously attached to the dynamically deployed device.

21. The system of claim 1, wherein the guide comprises a plurality of loops.

22. A module that integrates a dynamically deployed device with a seat belt of a vehicle, the module comprising:
(a) a housing having a first compartment, a second compartment, and a slot between the first and second compartments, wherein the slot is adapted to receive the seat belt;
(b) a dynamically deployed device disposed in the first compartment and attached to the housing; and
(c) a guide disposed in the second compartment, wherein the guide is attached to the dynamically deployed device such that the slot is enclosed between the dynamically deployed device and the guide.

23. The module of claim 22, further comprising a retaining ring that attaches the dynamically deployed device to the housing.

24. The module of claim 22, wherein the dynamically deployed device contains a port and the module further comprises an inflator in fluid communication with the port.

25. The module of claim 22, further comprising a cover mounted over the first compartment and the second compartment.

26. The module of claim 22, wherein the housing is made of a first material and the slot is coated with a second material having a coefficient of friction less than the first material.

27. The module of claim 22, wherein the guide comprises a plurality of loops attached to the dynamically deployed device.

28. The module of claim 22, wherein the guide comprises a rectangular piece of material having two short edges and two long edges, and wherein the long edges are attached to the dynamically deployed device.

29. The module of claim 22, further comprising an anchor that attaches the module to the vehicle.

30. The module of claim 29, wherein the anchor attaches the seat belt to the vehicle.

31. A method for protecting an occupant of a vehicle comprising:
anchoring a dynamically deployed device, in an undeployed state, to the vehicle;
attaching a guide to the dynamically deployed device to create a channel between the guide and the dynamically deployed device;
disposing a seat belt in the channel;
deploying the dynamically deployed device; and
engaging the guide with the seat belt to guide the deploying dynamically deployed device to an inflated position.

32. The method of claim 31, wherein, before deploying the dynamically deployed device, the seat belt restraint travels freely through the channel.

33. The method of claim 31, wherein the seat belt comprises a shoulder seat belt of a three-point seat belt restraint system, and wherein the guide engages the shoulder seat belt along a majority of the length of the shoulder seat belt.

34. The method of claim 31, wherein the seat belt comprises a lap belt of a three-point seat belt restraint system, and wherein the guide engages the lap belt along a majority of the length of the lap belt.

35. The method of claim 34, wherein the dynamically deployed device is a lap air bag.

36. The method of claim 31, wherein the seat belt comprises a lap belt of a three-point seat belt restraint system, and wherein the dynamically deployed device is a torso air bag.

37. A method for protecting an occupant of a vehicle comprising:
anchoring an uninflated dynamically deployed device to the vehicle;
slideably attaching the uninflated dynamically deployed device to a seat belt of the vehicle;
inflating the uninflated dynamically deployed device such that the dynamically deployed device slides along the seat belt; and
holding the inflated dynamically deployed device in position with the seat belt.

38. The method of claim 37, wherein slideably attaching comprises:
attaching a guide to the dynamically deployed device to create a channel between the dynamically deployed device and the guide; and
disposing the seat belt in the channel.

39. The method of claim 38, wherein the guide comprises at least one loop.

40. The method of claim 38, wherein the guide comprises a rectangular piece of material having two short edges and two long edges, and wherein the long edges are attached to the dynamically deployed device.

41. A system for protecting an occupant of a vehicle comprising:
(a) means for anchoring an uninflated dynamically deployed device to the vehicle; and
(b) means for slideably attaching the uninflated dynamically deployed device to a seat belt of the vehicle such that the dynamically deployed device, when deployed, slides along the seat belt.

42. A system for protecting an occupant of a vehicle comprising:
(a) a dynamically deployed device;
(b) a guide having a first portion, a second portion, and a third portion, wherein the second portion is located between the first portion and the third portion, and wherein the first portion and the third portion are attached to the dynamically deployed device and the second portion is disposed apart from the dynamically deployed device; and
(c) a housing that stores the dynamically deployed device and the guide, wherein the housing has a slot disposed between the second portion of the guide and the dynamically deployed device.

43. The system of claim 42, wherein the slot is adapted to receive a seat belt and to inhibit the seat belt from contacting the dynamically deployed device and the guide when the dynamically deployed device is uninflated.

44. The system of claim 42, wherein the guide comprises a rectangular piece of material having a first long edge, a second long edge, and two short edges, and wherein the first long edge is the first portion and the second long edge is the third portion.

45. The system of claim 42, wherein the dynamically deployed device is attached to the housing and the housing is attached to the vehicle.
